(19) United States
(12) Patent Application Publication
(10) Pub. No.: US 2026/0281877 A1
(43) Pub. Date: Sep. 17, 2026

(54) CONCATENATING ON-DEMAND SSB IN HALF FRAME

(71) Applicant: Samsung Electronics Co., Ltd., Suwon-si (KR)

(72) Inventor: Hongbo Si, Allen, TX (US)

(21) Appl. No.: 19/554,505

(22) Filed: Mar. 2, 2026

Related U.S. Application Data
(60) Provisional application No. 63/773,130, filed on Mar. 17, 2025.

(51) Int. Cl. H04W 48/14; H04W 28/06

(52) U.S. Cl. CPC H04W 48/14; H04W 28/06

(57) ABSTRACT

Apparatuses and methods for concatenating an on-demand synchronization signal block (SSB) in a half frame A method performed by a user equipment includes receiving a set of higher layer parameters, the set of higher layer parameters including a time offset, a first configuration for a first SSB, and a second configuration for a second SSB, and determining, based on the first configuration, a first set of candidate SSB occasions in a half frame for the first SSB. The method further includes determining, based on the second configuration, a second set of candidate SSB occasions in the half frame for the second SSB, wherein the second set of candidate SSB occasions occurs after the first set of candidate SSB occasions with respect to the time offset and receiving a SSB based on the first and second sets of candidate SSB occasions.

### CROSS-REFERENCE TO RELATED AND CLAIM OF PRIORITY

The present application claims priority under 35 U.S.C. § 119(e) to U.S. Provisional Patent Application No. 63/773,130 filed on Mar. 17, 2025, which is hereby incorporated by reference in its entirety.

### TECHNICAL FIELD

The present disclosure relates generally to wireless communication systems and, more specifically, the present disclosure is related to a method and apparatus of concatenating an on-demand synchronization signals block (SSB) in a half frame.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to a method and apparatus of concatenating an on-demand SSB in a half frame.

In one embodiment, a user equipment (UE) is provided. The UE includes a transceiver configured to receive a set of higher layer parameters, the set of higher layer parameters including a time offset, a first configuration for a first SSB, and a second configuration for a second SSB. The UE further includes a processor operably coupled to the transceiver. The processor is configured to determine, based on the first configuration, a first set of candidate SSB occasions in a half frame for the first SSB and determine, based on the second configuration, a second set of candidate SSB occasions in the half frame for the second SSB. The second set of candidate SSB occasions occurs after the first set of candidate SSB occasions with respect to the time offset. The transceiver is further configured to receive a SSB based on the first and second sets of candidate SSB occasions.

In another embodiment a method of a UE in a wireless communication system is provided. The method includes receiving a set of higher layer parameters, the set of higher layer parameters including a time offset, a first configuration for a first SSB, and a second configuration for a second SSB, and determining, based on the first configuration, a first set of candidate SSB occasions in a half frame for the first SSB. The method further includes determining, based on the second configuration, a second set of candidate SSB occasions in the half frame for the second SSB, wherein the second set of candidate SSB occasions occurs after the first set of candidate SSB occasions with respect to the time offset and receiving a SSB based on the first and second sets of candidate SSB occasions.

In yet another embodiment, a base station (BS) in a wireless communication system is provided. The BS includes a transceiver configured to transmit a set of higher layer parameters, the set of higher layer parameters including a time offset, a first configuration for a first SSB, and a second configuration for a second SSB and a processor operably coupled to the transceiver. The processor is configured to determine, based on the first configuration, a first set of candidate SSB occasions in a half frame for the first SSB and determine, based on the second configuration, a second set of candidate SSB occasions in the half frame for the second SSB. The second set of candidate SSB occasions occurs after the first set of candidate SSB occasions with respect to the time offset. The transceiver is further configured to transmit a SSB based on the first and second sets of candidate SSB occasions.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of an on-demand SSB transmission indicated by a BS according to embodiments of the present disclosure;

FIG. 6 illustrates an example method for concatenating always on (AO) SSB and on-demand (OD) SSB according to embodiments of the present disclosure;

FIG. 7 illustrates an example of AO-SSB not being transmitted outside the time offset according to embodiments of the present disclosure;

FIG. 8 an example method performed by a UE in a wireless communication system according to embodiments of the present disclosure;

FIG. 9 illustrates an example method for concatenating AO-SSB and OD-SSB according to embodiments of the present disclosure;

FIG. 10 illustrates an example of candidate SSB occasions for OD-SSB extended from candidate SSB occasions for AO-SSB according to embodiments of the present disclosure;

FIG. 11 illustrates an example method for concatenating AO-SSB and OD-SSB according to embodiments of the present disclosure;

FIG. 12 illustrates an example of candidate SSB occasions for OD-SSB extended from candidate SSB occasions for AO-SSB according to embodiments of the present disclosure; and

FIG. 13 illustrates an example method performed by a UE in a wireless communication system according to embodiments of the present disclosure.

### DETAILED DESCRIPTION

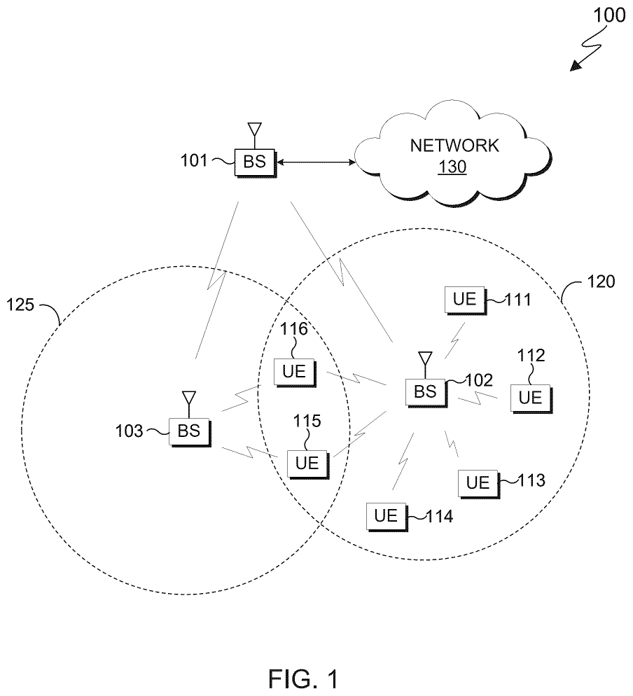

FIGS. 1-13 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211v17.1.0 , “NR; Physical channels and modulation” (herein, “REF 1”); 3GPP TS 38.212v17.1.0 , “NR; Multiplexing and channel coding” (herein, “REF 2”); 3GPP TS 38.213v17.1.0 , “NR; Physical layer procedures for control” (herein, “REF 3”); 3GPP TS 38.214v17.1.0 , “NR; Physical layer procedures for data” (herein, “REF 4”); and 3GPP TS 38.331v17.1.0 , “NR; Radio Resource Control (RRC) protocol specification” (herein, “REF 5”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101 (e.g., base station, eNB, gNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for utilizing an on-demand SSB that has been concatenated in a half frame. In certain embodiments, one or more of the BSs 101-103 include circuitry, programing, or a combination thereof to enable concatenation of an on-demand SSB in a half frame.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

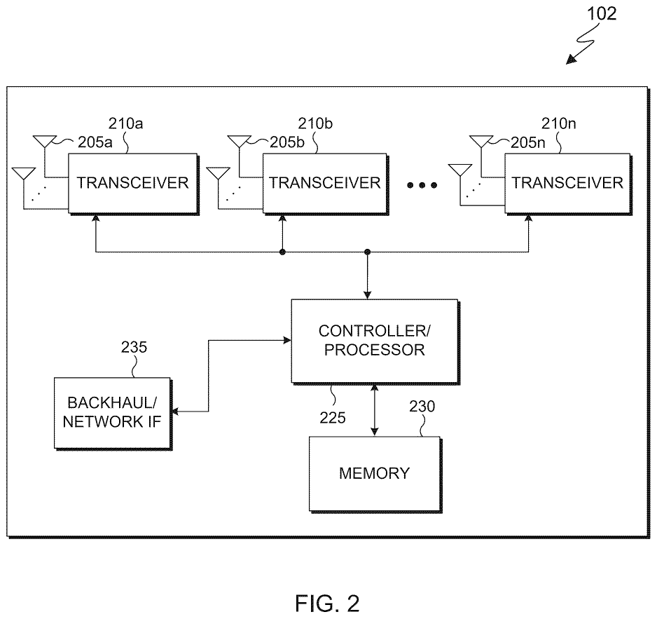

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of the present disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for concatenating an on-demand SSB in a half frame. Any of a wide variety of other functions could be supported in the BS 102 by the controller/processor 225.

The controller/processor 225 is also capable of executing programs and other processes resident in the memory 230, such as processes to enable concatenation of an on-demand SSB in a half frame. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

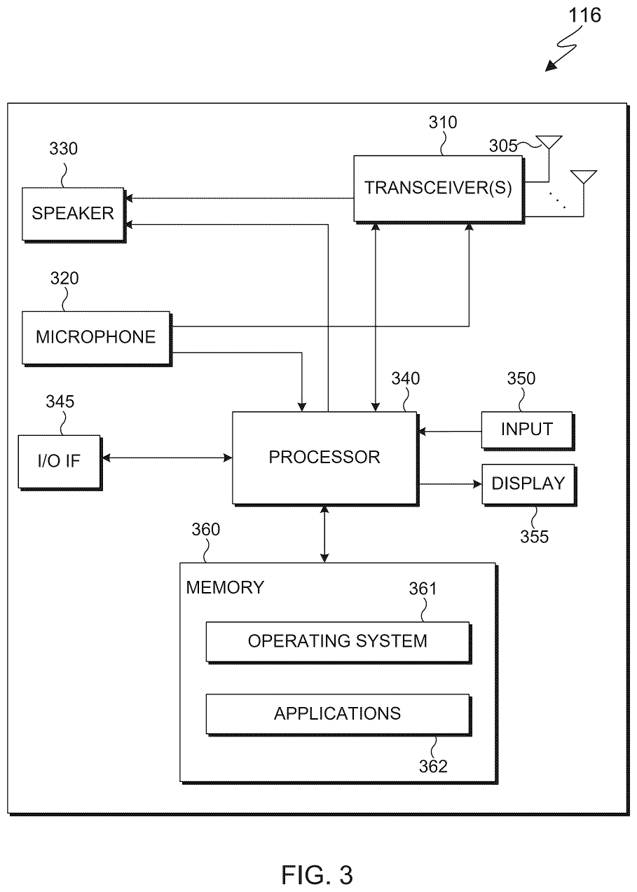

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing an on-demand SSB that has been concatenated in a half frame as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

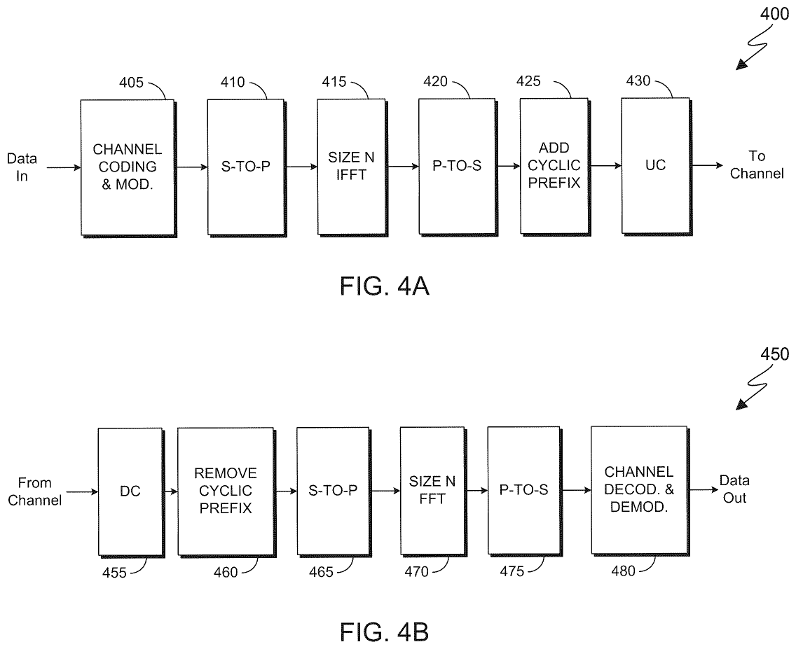

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 and/or the receive path 450 is configured for supporting an on-demand SSB that has been concatenated in a half frame as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 and may implement a receive path 450 for receiving in the downlink from the BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In new radio (NR), for a secondary cell (SCell) implemented with periodic synchronization signals/physical broadcast channel (SS/PBCH) block transmission (or always-on SSB), a UE can be provided with a configuration for radio resource management (RRM) measurement based on the periodic SS/PBCH block, wherein the configuration can be provided by a radio resource control (RRC) parameter. After the RRM measurement, the BS can provide a configuration of the SCell, e.g., by another RRC parameter. The UE can be further provided with a medium access control (MAC) control element (CE) indicating an activation of the SCell, and by using the periodic SS/PBCH blocks on the SCell, or tracking reference signal (TRS) if configured, or the SS/PBCH blocks on the primary cell (PCell) when the SCell is without periodic SS/PBCH block transmission, the UE can get synchronized with the SCell and get ready to transmit or receive on the SCell. After activation of the SCell, if the SCell gets loss of synchronization, the UE can use the periodic SS/PBCH block for resynchronization. Since SS/PBCH block is transmitted on the SCell periodically, the power consumption for SS/PBCH block can be significantly large. To reduce the power consumption, on-demand SSB can be supported on the SCell.

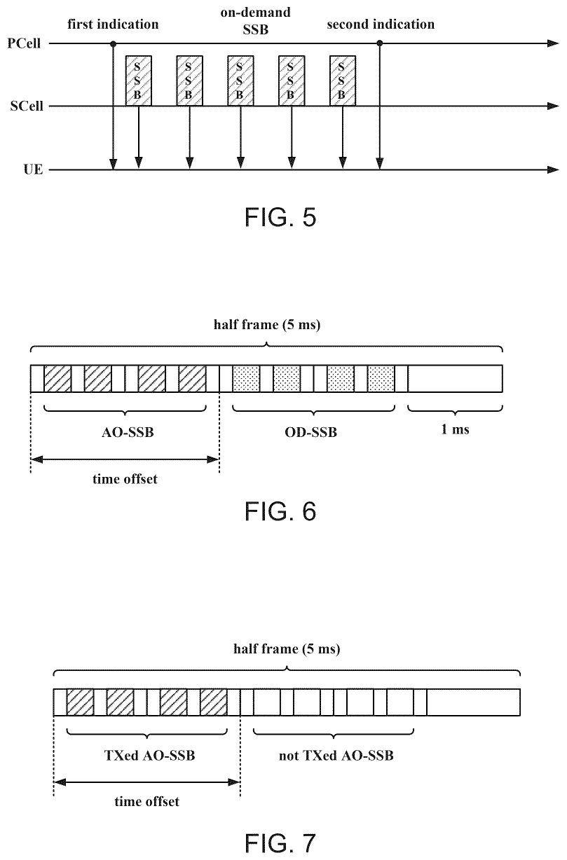

FIG. 5 illustrates an example of an on-demand SSB transmission indicated by a BS according to embodiments of the present disclosure. For example, the on-demand SSB transmission can be implemented by BS 102 of FIG. 1. This example is for illustration only and other embodiments can be used without departing from the scope of the present disclosure.

As illustrated in FIG. 5, on-demand SSB(s) can be triggered, for example, to be transmitted by a first indication (e.g., a first DCI format, a first MAC CE, or a first higher layer parameter) from the BS and/or triggered to be terminated by a second indication (e.g., a second DCI format, a first MAC CE, or a first higher layer parameter) from the BS. For some example procedures, the second indication can be absent and the UE assumes the triggered on-demand SSB transmission is not terminated, e.g., periodic manner after triggered.

However, both always-on SSB (e.g., periodic SSB) and on-demand SSB follow transmission patterns using a half frame as the unit, and when both types of SSBs are transmitted on the same cell, they may be in different half frames and the time duration of the concatenated transmission burst would be longer than a half frame, which may not be energy efficient from the network point of view. This disclosure includes embodiments and examples for concatenating always-on SSB (AO-SSB) and on-demand SSB (OD-SSB) to be confined within a same half frame for network energy saving.

For one example, this disclosure can be applicable for RRC_CONNECTED mode.

For another example, this disclosure can be applicable for RRC_IDLE mode.

For yet another example, this disclosure can be applicable for RRC_INACTIVE mode.

For one example, this disclosure can be applicable for a PCell.

For another example, this disclosure can be applicable for an SCell.

For yet another example, this disclosure can be applicable for a PSCell.

For one example, this disclosure can be applicable for AO-SSB as cell-defining SSB (e.g., with associated SIB1 transmission).

For another example, this disclosure can be applicable for AO-SSB as non-cell-defining SSB (e.g., without associated SIB1 transmission).

For one example, this disclosure can be applicable for AO-SSB located at a frequency layer given by a synchronization raster entry.

For another example, this disclosure can be applicable for AO-SSB located at a frequency layer not given by a synchronization raster entry.

For one example, this disclosure can be applicable for AO-SSB and OD-SSB having the same center frequency.

For one example, this disclosure can be applicable when the configurations (e.g., periodicity, system frame number (SFN) offset, or half frame index) for OD-SSB indicate the OD-SSB is in the same half frame as the AO-SSB (e.g., not considering any time offset smaller than a half frame).

Further in NR, a default SSB time domain pattern within a half frame can be determined as one form the following cases, wherein index 0 corresponds to the first symbol of the first slot in a half frame including the SSB, and L̅ₘₐₓ is the total number of candidate SS/PBCH blocks in the half frame:
Case A—15 kHz SCS: the first symbols of the candidate SS/PBCH blocks have indexes of |2,8|+14·n.
   For operation without shared spectrum channel access:
      For carrier frequencies smaller than or equal to 3 GHz, n=0,1, and L̅ₘₐₓ=4.
      For carrier frequencies within FR1 larger than 3 GHz, n=0,1,2,3, and L̅ₘₐₓ=8
   For operation with shared spectrum channel access, as described in [15, REF 3], n=0, 1, 2, 3, 4, and L̅ₘₐₓ=10.
Case B—30 kHz SCS: the first symbols of the candidate SS/PBCH blocks have indexes |4,8,16,20|+28·n.
   For carrier frequencies smaller than or equal to 3 GHz, n=0, and L̅ₘₐₓ=4.
   For carrier frequencies within FR1 larger than 3 GHz, n=0,1, and L̅ₘₐₓ=8.
Case C—30 kHz SCS: the first symbols of the candidate SS/PBCH blocks have indexes |2,8|+14·n.
   For operation without shared spectrum channel access:
      For paired spectrum operation
         For carrier frequencies smaller than or equal to 3 GHz, n=0,1, and L̅ₘₐₓ=4.
         For carrier frequencies within FR1 larger than 3 GHz, n=0,1,2,3, and L̅ₘₐₓ=8.
      For unpaired spectrum operation
         For carrier frequencies smaller than 1.88 GHz, n=0,1, and L̅ₘₐₓ=4.
         For carrier frequencies within FR1 equal to or larger than 1.88 GHz, n=0,1,2,3, and L̅ₘₐₓ=8.
   For operation with shared spectrum channel access, n=0, 1, 2, 3, 4, 5, 6, 7, 8, 9, and L̅ₘₐₓ=20.
Case D—120 kHz SCS: the first symbols of the candidate SS/PBCH blocks have indexes |4,8,16,20|+28·n. For carrier frequencies within FR2 and FR2-NTN, n=0, 1, 2, 3, 5, 6, 7, 8, 10, 11, 12, 13, 15, 16, 17, 18, and L̅ₘₐₓ=64.
Case E—240 kHz SCS: the first symbols of the candidate SS/PBCH blocks have indexes |8,12,16,20,32,36,40,44|+56·n. For carrier frequencies within FR2-1 and FR2-NTN, n=0, 1, 2, 3, 5, 6, 7, 8, and L̅ₘₐₓ=64.
Case F—480 kHz SCS: the first symbols of the candidate SS/PBCH blocks have indexes |2, 9|+14·n. For carrier frequencies within FR2-2, n=0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, and L̅ₘₐₓ=64.
Case G—960 Khz Scs: the First Symbols of the Candidate Ss/pbch Blocks Have Indexes |2, 9|+14·n. for Carrier Frequencies Within Fr2-2, n=0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, and L̅ₘₐₓ=64.

As introduced above, the present disclosure focuses on on-demand SSB transmission with a time offset to the always-on SSB transmission, wherein the time offset is smaller than a half frame. More precisely, the following aspects are included in this disclosure:
Transmission pattern between on-demand SSB and always-on SSB
Determination of the time offset
Indication of on-demand SSB
Example UE procedure
A first concatenating pattern
   Candidate SSB occasion determination
   Actually transmitted SSB determination
A second concatenating pattern
   Candidate SSB occasion determination
   Actually transmitted SSB determination

Further, the present disclosure focuses on the procedure for activation, adaptation, and deactivation of the on-demand SSB (OD-SSB). More precisely, the following aspects are included in the invention:
Configuration for On-demand Ssb
Using RRC parameter for activating on-demand SSB transmission
   Timeline for using RRC parameter for activating on-demand SSB transmission
   UE procedure for using RRC parameter for activating on-demand SSB transmission
Using MAC CE for activating, adapting, and deactivating on-demand SSB transmission
   Timeline for using MAC CE for adapting parameters for on-demand SSB transmission
   UE procedure for using MAC CE for adapting on-demand SSB transmission

In the present disclosure, an example transmission pattern between on-demand SSB and always-on SSB is provided.

FIG. 6 illustrates an example method for concatenating AO-SSB and OD-SSB according to embodiments of the present disclosure. For example, the method can be implemented by BS 102 of FIG. 1. This example is for illustration only and other embodiments can be used without departing from the scope of the present disclosure.

In one embodiment, as illustrated in FIG. 6, an OD-SSB burst can start after an AO-SSB burst with a time offset such that the OD-SSB burst and the AO-SSB burst are starting in the same half frame, e.g., the time offset is smaller than a half frame (5 ms).

FIG. 7 illustrates an example of AO-SSB not being transmitted outside the time offset according to embodiments of the present disclosure. For example, this non-transmission can be implemented by BS 102 of FIG. 1. This example is for illustration only and other embodiments can be used without departing from the scope of the present disclosure.

In one further implementation, as illustrated in FIG. 7, for AO-SSB, a UE can assume the SSB is not transmitted in the candidate SSB occasions outside the time offset (if any), or the UE can assume the SSB may be transmitted in the candidate SSB occasions within the time offset.

In the present disclosure, examples for determining the time offset are provided.

In one example, the time offset can be explicitly configured, e.g., by higher layer parameter such as a configuration of the corresponding serving cell.
For one sub-example, the configuration can be based on two candidate values, wherein one value corresponds to 0 ms time offset (e.g., no time offset between 0 and 5 ms), and another value corresponds to a non-zero time offset (e.g., a time offset between 0 and 5 ms).
   For one further implementation, the non-zero time offset can be pre-determined in the specification for system operation, and common for SCSs of SSB and/or maximum number of candidate SSB in a half frame, such as pre-determined as 0.5 ms, 1 ms, 2 ms, or 2.5 ms.
   For another further implementation, the non-zero time offset can be pre-determined in the specification for system operation, and may further depend on the subcarrier spacing (SCS) of SSB and/or a (maximum) number of candidate SSB in a half frame (e.g., L̅ₘₐₓ). For one instance, the time offset can be 1 ms, at least when SCS of SSB is 30 kHz and/or a (maximum) number of candidate SSB in a half frame is 4; and/or when SCS of SSB is 480 kHz or 960 kHz and/or a (maximum) number of candidate SSB in a half frame is 64. For another instance, the time offset can be 2 ms, when SCS of SSB is 15 kHz and/or a (maximum) number of candidate SSB in a half frame is 4; and/or when SCS of SSB is 30 kHz and/or a (maximum) number of candidate SSB in a half frame is 8. For yet another instance, the time offset can be 2.5 ms, when SCS of SSB is 240 kHz and/or a (maximum) number of candidate SSB in a half frame is 64; and/or when SCS of SSB is 15 kHz and/or a (maximum) number of candidate SSB in a half frame is 8. For yet another instance, the time offset can be 2.5 ms, except for the exemplified instances in the disclosure wherein the time offset can be a different value.
For another sub-example, if the configuration is not provided, the UE can assume no time offset between 0 and 5 ms is applied between the AO-SSB and OD-SSB; otherwise, the UE can assume a non-zero time offset (e.g., time offset between 0 and 5 ms) can be applied between the AO-SSB and OD-SSB, e.g., in the same half frame.
   For one further implementation, the non-zero time offset can be pre-determined in the specification for system operation, and common for SCSs of SSB and/or maximum number of candidate SSB in a half frame, such as pre-determined as 0.5 ms, 1 ms, 2 ms, or 2.5 ms.
   For another further implementation, the non-zero time offset can be pre-determined in the specification for system operation, and may further depend on the subcarrier spacing (SCS) of SSB and/or a (maximum) number of candidate SSB in a half frame (e.g., L̅ₘₐₓ). For one instance, the time offset can be 1 ms, at least when SCS of SSB is 30 kHz and/or a (maximum) number of candidate SSB in a half frame is 4; and/or when SCS of SSB is 480 kHz or 960 kHz and/or a (maximum) number of candidate SSB in a half frame is 64. For another instance, the time offset can be 2 ms, when SCS of SSB is 15 kHz and/or a (maximum) number of candidate SSB in a half frame is 4; and/or when SCS of SSB is 30 kHz and/or a (maximum) number of candidate SSB in a half frame is 8. For yet another instance, the time offset can be 2.5 ms, when SCS of SSB is 240 kHz and/or a (maximum) number of candidate SSB in a half frame is 64; and/or when SCS of SSB is 15 kHz and/or a (maximum) number of candidate SSB in a half frame is 8. For yet another instance, the time offset can be 2.5 ms, except for the exemplified instances in the disclosure wherein the time offset can be a different value.
For yet another sub-example, the configuration can be based on multiple candidate values, wherein one of candidate values corresponds to 0 ms time offset (e.g., no time offset between 0 and 5 ms), and other candidate value(s) correspond to non-zero time offset(s) (e.g., time offset(s) between 0 and 5 ms).
   For one further implementation, candidate values for a non-zero time offset can be from 0.5 ms, 1 ms, 2 ms, or 2.5 ms.
For yet another sub-example, if the configuration is not provided, the UE can assume no time offset between 0 and 5 ms is applied between the AO-SSB and OD-SSB; otherwise, the UE can assume a non-zero time offset (e.g., time offset between 0 and 5 ms) can be applied between the AO-SSB and OD-SSB, based on the configuration, wherein the configuration can be based on multiple candidate non-zero time offset values.
   For one further implementation, candidate values for a non-zero time offset can be from 0.5 ms, 1 ms, 2 ms, or 2.5 ms.

In another example, the time offset can be implicitly determined based on the configuration of actually transmitted SSB for AO-SSB and/or OD-SSB (e.g., ssb-PositionsInBurst and/or od-ssb-PositionsInBurst, respectively).
For one instance, the time offset can correspond to a number of milliseconds wherein the corresponding candidate SSB occasions within the time offset can be indicated as no actually transmitted AO-SSB, based on the configuration of actually transmitted SSB for AO-SSB (e.g., ssb-PositionsInBurst).
For another instance, the time offset can correspond to a number of milliseconds wherein the corresponding candidate SSB occasions within the time offset can be indicated as actually transmitted OD-SSB, based on the configuration of actually transmitted SSB for OD-SSB (e.g., od-ssb-PositionsInBurst).
For yet another instance, the time offset can correspond to a number of milliseconds wherein the corresponding candidate SSB occasions within the time offset can be indicated as no actually transmitted AO-SSB, and the corresponding candidate SSB occasions within the time offset can be indicated as actually transmitted OD-SSB, based on the configuration of actually transmitted SSB for AO-SSB (e.g., ssb-PositionsInBurst) and the configuration of actually transmitted SSB for OD-SSB (e.g., od-ssb-PositionsInBurst), respectively.

In the present disclosure, examples of indicating the on-demand SSB are provided.

For one example, the OD-SSB can include information on the associated SSB is an OD-SSB. After a UE receives a SSB, the UE is able to know whether the received SSB is an AO-SSB or an OD-SSB.

For one sub-example, a frequency location of the OD-SSB (e.g., center frequency) can indicate whether the SSB is an AO-SSB or an OD-SSB.

For another sub-example, a PSS sequence of OD-SSB can be different from a PSS sequence for AO-SSB.

For yet another sub-example, a SSS sequence of OD-SSB can be different from a SSS sequence for AO-SSB.

For yet another sub-example, a DM-RS sequence of PBCH in OD-SSB can be different from a DM-RS sequence of PBCH in AO-SSB.

For yet another sub-example, one bit in the PBCH payload can be used for indicating the SSB is AO-SSB or OD-SSB.

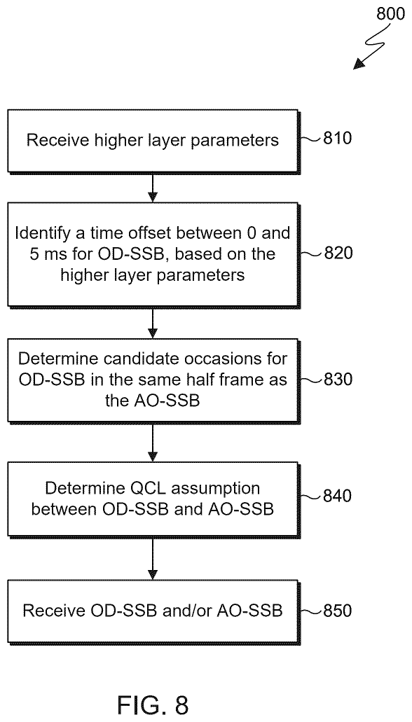

FIG. 8 illustrates an example method 800 for receiving AO-SSB and OD-SSB that may be performed by a UE in a wireless communication system according to embodiments of the present disclosure. The method 800 of can be performed by any of the UEs 111-116 of FIG. 1, such as the UE 116 of FIG. 3, and a corresponding method can be performed by any of the BSs 101-103 of FIG. 1, such as BS 102 of FIG. 2. The method 800 is for illustration only and other embodiments can be used without departing from the scope of the present disclosure.

The method 800 begins with a UE receiving higher layer parameters (810). The UE then identifies a time offset between 0 and 5 ms for OD-SSB, based on the higher layer parameters (820). The UE then determines candidate occasions for OD-SSB in the same half frame as the AO-SSB (830). The UE then determines a quasi-co-location (QCL) assumption between OD-SSB and AO-SSB (840). The UE then receives OD-SSB and/or AO-SSB (850).

Although FIG. 8 illustrates one example method 800 of the actions taken by the UE for receiving AO-SSB and OD-SSB, various changes may be made to FIG. 8. For example, while shown as a series of steps, various steps in FIG. 8 could overlap, occur in parallel, occur in a different order, or occur any number of times.

In the present disclosure, a first example concatenation pattern for AO-SSB and OD-SSB is provided.

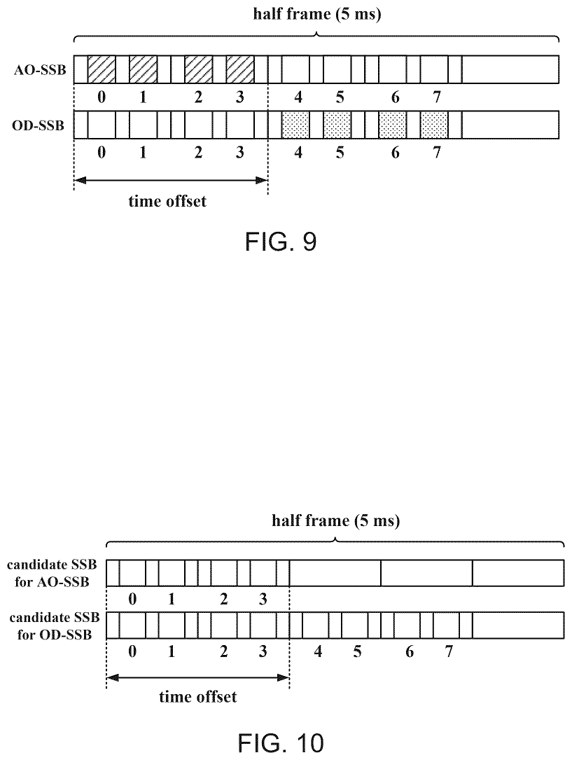

FIG. 9 illustrates an example method for concatenating AO-SSB and OD-SSB according to embodiments of the present disclosure. For example, the method can be implemented by BS 102 of FIG. 1. This example is for illustration only and other embodiments can be used without departing from the scope of the present disclosure.

In one embodiment, as illustrated in FIG. 9, candidate SSB occasions for AO-SSB in a half frame and candidate SSB occasions for OD-SSB in the half frame both start from the first slot of the half frame, and a UE can assume or expect AO-SSB is not transmitted in candidate SSB occasions for AO-SSB after a time offset (e.g., may be transmitted in candidate SSB occasions for AO-SSB within the time offset), and/or OD-SSB is not transmitted in the candidate SSB occasions for OD-SSB within the time offset (e.g., may be transmitted in candidate SSB occasions for OD-SSB after the time offset).

For one further implementation, a first set of candidate SSB occasions for AO-SSB corresponding to actually transmitted AO-SSB and a second set of candidate SSB occasions for OD-SSB corresponding to actually transmitted OD-SSB do not overlap.

For another further implementation, the time offset is smaller than a half frame (5 ms).

For yet another further implementation, this embodiment can be applicable for certain subcarrier spacing (SCS) of SSB and/or certain (maximum) number of candidate SSB in a half frame (e.g., L̅ₘₐₓ), e.g., for AO-SSB.

In the present disclosure, examples for determining candidate SSB occasions in a half frame with regard to the first concatenation pattern are provided.

In one example, the candidate SSB occasions in a half frame for AO-SSB can be same as the NR, e.g., according to one of Case A to Case G as described in the disclosure.

In one example, the candidate SSB occasions in a half frame for OD-SSB can be the same as the candidate SSB occasions in a half frame for AO-SSB, e.g., according to one of Case A to Case G as described in the disclosure.
For one further implementation, this example can be applicable when a duration of the AO-SSB burst according to the candidate SSB occasions in a half frame for AO-SSB (e.g., one from Case A to Case G) is larger than the time offset. For one instance, when AO-SSB is using Case A with L̅ₘₐₓ=8, and the time offset is 1 ms, or 2 ms or 2.5 ms. For another instance, when AO-SSB is using Case D with L̅ₘₐₓ=64, and the time offset is 2.5 ms.

FIG. 10 illustrates an example of candidate SSB occasions for OD-SSB extended from candidate SSB occasions for AO-SSB according to embodiments of the present disclosure. For example, the candidate SSB occasions can be utilized by BS 102 of FIG. 1. This example is for illustration only and other embodiments can be used without departing from the scope of the present disclosure.

As illustrated in FIG. 10, in this example, the candidate SSB occasions in a half frame for OD-SSB can be a superset of the candidate SSB occasions in a half frame for AO-SSB.
For one further implementation, this example can be applicable when a duration of the AO-SSB burst according to the candidate SSB occasions in a half frame for AO-SSB (e.g., one from Case A to Case G) is no larger than the time offset.

For one sub-example, the (maximum) number of candidate SSB in a half frame (e.g., L̅ₘₐₓ, OD) can be extended for OD-SSB, using the time domain pattern (e.g., starting OFDM symbols for the candidate SSB in slots).
For one instance, when AO-SSB is using Case A with L̅ₘₐₓ=4, and the time offset is 2 ms, the value of n for OD-SSB can be extended to n=0, 1, 2, 3 and L̅ₘₐₓ, OD=8.
For another instance, when AO-SSB is using Case A with L̅ₘₐₓ=4, and the time offset is 2.5 ms, the value of n for OD-SSB can be extended to n=0, 1, 3, 4 and L̅_{max,OD}=8.
For yet another instance, when AO-SSB is using Case A with L̅ₘₐₓ=8, and the time offset is 2.5 ms, the value of n for OD-SSB can be extended to n=0, 1, 2, 3, 4 and L̅_{max,OD}=10.
For yet another instance, when AO-SSB is using Case B with L̅ₘₐₓ=4, and the time offset is 1 ms, the value of n for OD-SSB can be extended to n=0, 1 and L̅_{max,OD}=8.
For yet another instance, when AO-SSB is using Case B with L̅ₘₐₓ=4, and the time offset is 2 ms, the value of n for OD-SSB can be extended to n=0, 2 and L̅_{max,OD}=8.
For yet another instance, when AO-SSB is using Case B with L̅ₘₐₓ=8, and the time offset is 2 ms, the value of n for OD-SSB can be extended to n=0, 1, 2, 3 and L̅_{max,OD}=16.
For yet another instance, when AO-SSB is using Case C with L̅ₘₐₓ=4, and the time offset is 1 ms, the value of n for OD-SSB can be extended to n=0, 1, 2, 3 and L̅_{max,OD}=8.
For yet another instance, when AO-SSB is using Case C with L̅ₘₐₓ=4, and the time offset is 2 ms, the value of n for OD-SSB can be extended to n=0, 1, 4, 5 and L̅_{max,OD}=8.
For yet another instance, when AO-SSB is using Case C with L̅ₘₐₓ=4, and the time offset is 2.5 ms, the value of n for OD-SSB can be extended to n=0, 1, 5, 6 and L̅_{max,OD}=8.
For yet another instance, when AO-SSB is using Case C with L̅ₘₐₓ=8, and the time offset is 2 ms, the value of n for OD-SSB can be extended to n=0, 1, 2, 3, 4, 5, 6, 7 and L̅_{max,OD}=16.
For yet another instance, when AO-SSB is using Case C with L̅ₘₐₓ=8, and the time offset is 2.5 ms, the value of n for OD-SSB can be extended to n=0, 1, 2, 3, 5, 6, 7, 8 and L̅_{max,OD}=16.
For yet another instance, when AO-SSB is using Case E with L̅ₘₐₓ=64, and the time offset is 2.5 ms, the value of n for OD-SSB can be extended to n=0, 1, 2, 3, 5, 6, 7, 8, 10, 11, 12, 13, 15, 16, 17, 18, 20, 21, 22, 23, 25, 26, 27, 28, 30, 31, 32, 33, 35, 36, 37, 38 and L̅_{max,OD}=128.
For another sub-example, candidate SSB occasions in a half frame for OD-SSB in a first period starting from the beginning of the half frame and with a duration of the time offset is same as the candidate SSB occasions in a half frame for OD-SSB in a second period starting from the time offset and with a duration of the time offset.
For one further implementation, candidate SSB occasions in a half frame for OD-SSB and candidate SSB occasions in a half frame for AO-SSB in the first period starting from the beginning of the half frame and with a duration of the time offset are same.
For another further implementation, the candidate SSB occasions for OD-SSB are repeated after the time offset, with a duration of the time offset.

For yet another sub-example, the candidate SSB occasions for OD-SSB can be repeated 5/O times, wherein O is the time offset in a unit of ms, and each repetition is with a duration of the time offset.
For one further implementation, candidate SSB occasions in a half frame for OD-SSB and candidate SSB occasions in a half frame for AO-SSB in the first period starting from the beginning of the half frame and with a duration of the time offset are same.

In the present disclosure, examples for determining the actually transmitted SSB with regard to the first concatenation pattern are provided.

In one example, for AO-SSB, a UE can assume the SSB is not transmitted in the candidate SSB occasions outside the (configured) time offset in the half frame (if any), or the UE can assume the SSB may be transmitted in the candidate SSB occasions within the (configured) time offset.

In another example, for AO-SSB, a UE can assume the indication of actually transmitted SSB (e.g., ssb-PositionsInBurst) may indicate actually transmitted SSB being in the candidate SSB occasions within the (configured) time offset, e.g., the bits corresponding to candidate SSB occasions outside the (configured) time offset are all set to 0.

In yet another example, for AO-SSB, a UE may assume AO-SSB is transmitted in the period starting from the beginning of the half frame and with a duration of the time offset.

In one example, for OD-SSB, a UE can assume the SSB is not transmitted in the candidate SSB occasions within the (configured) time offset in the half frame, or the UE can assume the SSB may be transmitted in the candidate SSB occasions outside the (configured) time offset in the half frame.

In yet another example, a UE can assume OD-SSB is transmitted in the period starting after the time offset and with a duration same as the time offset.

In yet another example, a UE can assume OD-SSB is transmitted in the period starting after the time offset and ending at the end of the half frame, e.g., for the candidate SSB occasions for OD-SSB repeated 5/O times.

In yet another example, for OD-SSB, a UE can assume the indication of actually transmitted SSB (e.g., od-ssb-PositionsInBurst) may indicate actually transmitted SSB being in the candidate SSB occasions outside the (configured) time offset, e.g., the bits corresponding to candidate SSB occasions within the (configured) time offset are all set to 0 (e.g., first N_SSB bits are all set to 0, wherein N_SSB is a number of candidate SSB occasions in the period starting from the beginning of the half frame and with a duration of the time offset).
For one further implementation, candidate SSB occasions determined based on the indication of actually transmitted SSB for OD-SSB (e.g., od-ssb-PositionsInBurst) do not overlap with candidate SSB occasions determined based on the indication of actually transmitted SSB for AO-SSB (e.g., ssb-PositionsInBurst).
For another further implementation, AO-SSB with a (candidate) SSB index i and OD-SSB with a (candidate) SSB index i+N_SSB are quasi-co-located (QCLed), e.g., within a half frame or across half frames including the AO-SSB and/or OD-SSB transmission.
For yet another further implementation, the beams for actually transmitted AO-SSB and OD-SSB can be the same, e.g., the i-th bit in the indication of actually transmitted SSB for AO-SSB (e.g., ssb-PositionsInBurst) and the (i+N_SSB)-th bit in the indication of actually transmitted SSB for OD-SSB (e.g., od-ssb-PositionsInBurst) are the same.
For yet another further implementation, the beams for actually transmitted OD-SSB can be the same or a subset of the beams for actually transmitted AO-SSB, e.g., if the (i+N_SSB)-th bit in the indication of actually transmitted SSB for OD-SSB (e.g., od-ssb-PositionsInBurst) is set as 1, then the i-th bit in the indication of actually transmitted SSB for AO-SSB (e.g., ssb-PositionsInBurst) is also set as 1.

In yet another example, for OD-SSB, a UE can assume the indication of actually transmitted SSB (e.g., od-ssb-PositionsInBurst) may have bits setting to 1 in the first N_SSB bits, wherein N_SSB is a number of candidate SSB occasions in the period starting from the beginning of the half frame and with a duration of the time offset.
For one further implementation, i-th in the indication of actually transmitted SSB for OD-SSB (e.g., od-ssb-PositionsInBurst) indicates whether the OD-SSB is transmitted on the (i+N_SSB)-th candidate SSB occasion for OD-SSB.
For another further implementation, candidate SSB occasions determined based on the indication of actually transmitted SSB for OD-SSB (e.g., od-ssb-PositionsInBurst) do not overlap with candidate SSB occasions determined based on the indication of actually transmitted SSB for AO-SSB (e.g., ssb-PositionsInBurst).
For another further implementation, AO-SSB with a (candidate) SSB index i and OD-SSB with a (candidate) SSB index i+N_SSB are quasi-co-located (QCLed), e.g., within a half frame or across half frames including the AO-SSB and/or OD-SSB transmission.
For yet another further implementation, the beams for actually transmitted AO-SSB and OD-SSB can be the same, e.g., the indication of actually transmitted SSB for AO-SSB (e.g., ssb-PositionsInBurst) and the indication of actually transmitted SSB for OD-SSB (e.g., od-ssb-PositionsInBurst) are the same.
For yet another further implementation, the beams for actually transmitted OD-SSB can be the same or a subset of the beams for actually transmitted AO-SSB, e.g., the indication of actually transmitted SSB for OD-SSB (e.g., od-ssb-PositionsInBurst) is a subset of the indication of actually transmitted SSB for AO-SSB (e.g., ssb-PositionsInBurst).

For one example, a UE can be expected to receive or measure at least one of AO-SSB and/or OD-SSB.
For one further implementation, the UE can report a capability on receiving or measuring both AO-SSB and OD-SSB.
For another further implementation, the UE can indicate its preferred one or both types from AO-SSB and/or OD-SSB for reception or measurement in UE assistant information (UAI).

In the present disclosure, a second example concatenation pattern for AO-SSB and OD-SSB is provided.

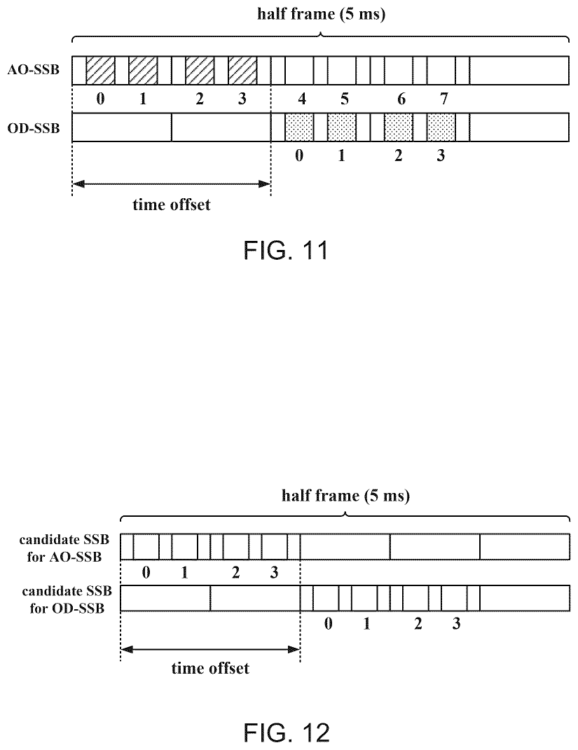

FIG. 11 illustrates an example method for concatenating AO-SSB and OD-SSB according to embodiments of the present disclosure. For example, the method can be implemented by BS 102 of FIG. 1. This example is for illustration only and other embodiments can be used without departing from the scope of the present disclosure.

In one embodiment, as illustrated in FIG. 11, candidate SSB occasions for OD-SSB in a half frame start after a time offset with respect to a beginning of a half frame, and a UE can assume or expect AO-SSB is not transmitted in candidate SSB occasions for AO-SSB after a time offset (e.g., may be transmitted in candidate SSB occasions for AO-SSB within the time offset), and/or OD-SSB is not transmitted in the candidate SSB occasions for OD-SSB within the time offset (e.g., may be transmitted in candidate SSB occasions for OD-SSB after the time offset).

For one further implementation, a first set of candidate SSB occasions for AO-SSB corresponding to actually transmitted AO-SSB and a second set of candidate SSB occasions for OD-SSB corresponding to actually transmitted OD-SSB do not overlap.

For another further implementation, the time offset is smaller than a half frame (5 ms).

For yet another further implementation, this embodiment can be applicable for certain subcarrier spacing (SCS) of SSB and/or certain (maximum) number of candidate SSB in a half frame (e.g., L̅ₘₐₓ), e.g., for AO-SSB.

In the present disclosure, examples for determining candidate SSB occasions in a half frame with regard to the second concatenation pattern are provided.

In one example, the candidate SSB occasions in a half frame for AO-SSB can be same as the NR, e.g., according to one of Case A to Case G as described in the disclosure.

FIG. 12 illustrates an example of candidate SSB occasions for OD-SSB extended from candidate SSB occasions for AO-SSB according to embodiments of the present disclosure. For example, the candidate SSB occasions can be utilized by BS 102 of FIG. 1. This example is for illustration only and other embodiments can be used without departing from the scope of the present disclosure.

As illustrated in FIG. 12, in this example, the candidate SSB occasions in a half frame for OD-SSB can start from the first slot after the time offset, and indexed starting from 0 in the time domain.

For one sub-example, candidate SSB occasions in a half frame for AO-SSB in a first period starting from the beginning of the half frame and with a duration of the time offset is same as the candidate SSB occasions in a half frame for OD-SSB in a second period starting from the time offset and with a duration of the time offset.
For one instance, when AO-SSB is using Case A with L̅ₘₐₓ=4, and the time offset is 2 ms, the first symbols of the candidate SSB for OD-SSB can be determined as |2, 8|+14·n with n=2, 3 and L̅_{max,OD}=4.
For another instance, when AO-SSB is using Case A with L̅ₘₐₓ=4, and the time offset is 2 ms or 2.5 ms, the first symbols of the candidate SSB for OD-SSB can be determined as |2, 8|+14·n with n=3, 4 and L̅_{max,OD}=4.
For yet another instance, when AO-SSB is using Case A with L̅ₘₐₓ=8, and the time offset is 2 ms, the first symbols of the candidate SSB for OD-SSB can be determined as |2, 8|+14·n with n=2, 3 and L̅_{max,OD}=4.
For yet another instance, when AO-SSB is using Case A with L̅ₘₐₓ=8, and the time offset is 2.5 ms, the first symbols of the candidate SSB for OD-SSB can be determined as |2, 8|+14·n with n=3, 4 and L̅_{max,OD}=4.
For yet another instance, when AO-SSB is using Case A with L̅ₘₐₓ=8, and the time offset is 2.5 ms, the first symbols of the candidate SSB for OD-SSB can be determined as |2, 8|+14·n with n=2.5, 3.5 and L̅_{max,OD}=4.
For yet another instance, when AO-SSB is using Case B with L̅ₘₐₓ=4, and the time offset is 1 ms, the first symbols of the candidate SSB for OD-SSB can be determined as |4, 8, 16, 20|+28·n with n=1 and L̅_{max,OD}=4.
For yet another instance, when AO-SSB is using Case B with L̅ₘₐₓ=4, and the time offset is 2 ms, the first symbols of the candidate SSB for OD-SSB can be determined as |4, 8, 16, 20|+28·n with n=2 and L̅_{max,OD}=4.
For yet another instance, when AO-SSB is using Case B with L̅ₘₐₓ=4, and the time offset is 2.5 ms, the first symbols of the candidate SSB for OD-SSB can be determined as |4, 8, 16, 20|+28·n with n=2.5 and L̅_{max,OD}=4.
For yet another instance, when AO-SSB is using Case B with L̅ₘₐₓ=8, and the time offset is 2 ms, the first symbols of the candidate SSB for OD-SSB can be determined as |4, 8, 16, 20|+28·n with n=2, 3 and L̅_{max,OD}=8.
For yet another instance, when AO-SSB is using Case B with L̅ₘₐₓ=8, and the time offset is 2.5 ms, the first symbols of the candidate SSB for OD-SSB can be determined as |4, 8, 16, 20|+28·n with n=2.5, 3.5 and L̅_{max,OD}=8.
For yet another instance, when AO-SSB is using Case C with L̅ₘₐₓ=4, and the time offset is 1 ms, the first symbols of the candidate SSB for OD-SSB can be determined as |2,8|+14·n with n=2, 3 and L̅_{max,OD}=4.
For yet another instance, when AO-SSB is using Case C with L̅ₘₐₓ=4, and the time offset is 2 ms, the first symbols of the candidate SSB for OD-SSB can be determined as |2,8|+14·n with n=4, 5 and L̅_{max,OD}=4.
For yet another instance, when AO-SSB is using Case C with L̅ₘₐₓ=4, and the time offset is 2.5 ms, the first symbols of the candidate SSB for OD-SSB can be determined as |2,8|+14·n with n=5, 6 and L̅_{max,OD}=4.
For yet another instance, when AO-SSB is using Case C with L̅ₘₐₓ=8, and the time offset is 2 ms, the first symbols of the candidate SSB for OD-SSB can be determined as |2,8|+14·n with n=4, 5, 6, 7 and L̅_{max,OD}=8.
For yet another instance, when AO-SSB is using Case C with L̅ₘₐₓ=8, and the time offset is 2.5 ms, the first symbols of the candidate SSB for OD-SSB can be determined as |2,8|+14·n with n=5, 6, 7, 8 and L̅_{max,OD}=8.
For yet another instance, when AO-SSB is using Case D with L̅ₘₐₓ=64, and the time offset is 2.5 ms, the first symbols of the candidate SSB for OD-SSB can be determined as |4, 8, 16, 20|+28·n with n=10, 11, 12, 13, 15, 16, 17, 18 and L̅_{max,OD}=32.
For yet another instance, when AO-SSB is using Case E with L̅ₘₐₓ=64, and the time offset is 2.5 ms, the first symbols of the candidate SSB for OD-SSB can be determined as |8, 12, 16, 20, 32, 36, 40, 44|+56·n with n=10, 11, 12, 13, 15, 16, 17, 18 and L̅_{max,OD}=64.

For one further implementation, the candidate SSB occasions for OD-SSB can be repeated 5/O-1 times, wherein O is the time offset in a unit of ms, and each repetition is with a duration of the time offset.

In the present disclosure, examples for determining the actually transmitted SSB with regard to the second concatenation pattern are provided.

In one example, for AO-SSB, a UE can assume the SSB is not transmitted in the candidate SSB occasions outside the (configured) time offset in the half frame (if any), or the UE can assume the SSB may be transmitted in the candidate SSB occasions within the (configured) time offset.

In another example, for AO-SSB, a UE can assume the indication of actually transmitted SSB (e.g., ssb-PositionsInBurst) may indicate actually transmitted SSB being in the candidate SSB occasions within the (configured) time offset, e.g., the bits corresponding to candidate SSB occasions outside the (configured) time offset are all set to 0.

In yet another example, for AO-SSB, a UE may assume AO-SSB is transmitted in the period starting from the beginning of the half frame and with a duration of the time offset.

In one example, for OD-SSB, a UE can assume the SSB is not transmitted in the candidate SSB occasions within the (configured) time offset in the half frame, or the UE can assume the SSB may be transmitted in the candidate SSB occasions outside the (configured) time offset in the half frame.

In yet another example, a UE can assume OD-SSB is transmitted in the period starting after the time offset and with a duration same as the time offset.

In yet another example, a UE can assume OD-SSB is transmitted in the period starting after the time offset and ending at the end of the half frame, e.g., for the candidate SSB occasions for OD-SSB repeated 5/O times.

In yet another example, for OD-SSB, a UE can assume the indication of actually transmitted SSB (e.g., od-ssb-PositionsInBurst) may have bits setting to 1 in the first N_SSB bits, wherein N_SSB is a number of candidate SSB occasions for OD-SSB in the period starting from the offset and with a duration of the time offset.
For one further implementation, candidate SSB occasions determined based on the indication of actually transmitted SSB for OD-SSB (e.g., od-ssb-PositionsInBurst) do not overlap with candidate SSB occasions determined based on the indication of actually transmitted SSB for AO-SSB (e.g., ssb-PositionsInBurst).
For another further implementation, AO-SSB with a (candidate) SSB index i and OD-SSB with a (candidate) SSB index i are quasi-co-located (QCLed), e.g., within a half frame or across half frames including the AO-SSB and/or OD-SSB transmission.
For yet another further implementation, the beams for actually transmitted AO-SSB and OD-SSB can be the same, e.g., the indication of actually transmitted SSB for AO-SSB (e.g., ssb-PositionsInBurst) and the indication of actually transmitted SSB for OD-SSB (e.g., od-ssb-PositionsInBurst) are the same.
For yet another further implementation, the beams for actually transmitted OD-SSB can be the same or a subset of the beams for actually transmitted AO-SSB, e.g., the indication of actually transmitted SSB for OD-SSB (e.g., od-ssb-PositionsInBurst) is a subset of the indication of actually transmitted SSB for AO-SSB (e.g., ssb-PositionsInBurst).

For one example, a UE can be expected to receive or measure at least one of AO-SSB and/or OD-SSB.
For one further implementation, the UE can report a capability on receiving or measuring both AO-SSB and OD-SSB.
For another further implementation, the UE can indicate its preferred one or both types from AO-SSB and/or OD-SSB for reception or measurement in UE assistant information (UAI).

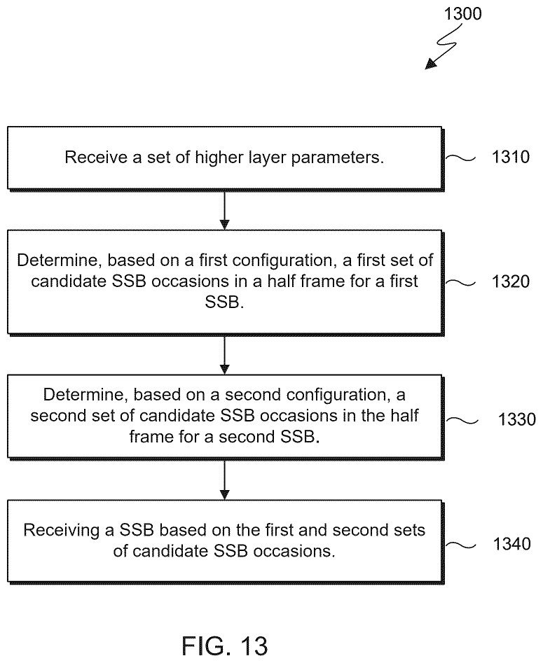

FIG. 13 illustrates an example method 1300 performed by a UE in a wireless communication system according to embodiments of the present disclosure. The method 1300 of can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1300 is for illustration only and other embodiments can be used without departing from the scope of the present disclosure.

The method 1300 begins with the UE receiving a set of higher layer parameters (1310). For example, in 1310, the set of higher layer parameters includes a time offset, a first configuration for a first SSB, and a second configuration for a second SSB. In various embodiments, a first frequency location of the first SSB is same as a second frequency location of the second SSB, a first transmission power of the first SSB is same as a second transmission power of the second SSB, a first cell identity of the first SSB is same as a second cell identity of the second SSB, and a first set of SSB indexes for the first SSB is same as a second set of SSB indexes for the second SSB. In various embodiments, the first SSB is a periodic SSB and the second SSB is an on-demand SSB.

The UE then determines, based on the first configuration, a first set of candidate SSB occasions in a half frame for the first SSB (1320). In various embodiments, the first set of candidate SSB occasions start from a beginning of the half frame. In various embodiments, the set of higher layer parameters further includes a bitmap indicating actually transmitted SSB indexes, and bits in the bitmap not corresponding to the first set of candidate SSB occasions are set to 0.

The UE then determines, based on the second configuration, a second set of candidate SSB occasions in the half frame for the second SSB (1330). For example, in 1330, the second set of candidate SSB occasions occurs after the first set of candidate SSB occasions with respect to the time offset. In various embodiments, the time offset is larger than 0 and smaller than the half frame. In various embodiments, the first and second sets of candidate SSB occasions are indexed from 0 in a time domain, and a first candidate SSB occasion from the first set of candidate SSB occasions and a second candidate SSB occasion from the second set of candidate SSB occasions are QCLed when the first and second candidate SSB occasions have a same index. The UE then receives a SSB based on the first and second sets of candidate SSB occasions (1340).

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a set of higher layer parameters, the set of higher layer parameters including a time offset, a first configuration for a first synchronization signals block (SSB), and a second configuration for a second SSB; and
a processor operably coupled to the transceiver, the processor configured to:
determine, based on the first configuration, a first set of candidate SSB occasions in a half frame for the first SSB; and
determine, based on the second configuration, a second set of candidate SSB occasions in the half frame for the second SSB,
wherein the second set of candidate SSB occasions occurs after the first set of candidate SSB occasions with respect to the time offset, and
wherein the transceiver is further configured to receive a SSB based on the first and second sets of candidate SSB occasions.

2. The UE of claim 1, wherein the time offset is larger than 0 and smaller than the half frame.

3. The UE of claim 1, wherein the first set of candidate SSB occasions start from a beginning of the half frame.

4. The UE of claim 1, wherein:
the first and second sets of candidate SSB occasions are indexed from 0 in a time domain, and
a first candidate SSB occasion from the first set of candidate SSB occasions and a second candidate SSB occasion from the second set of candidate SSB occasions are quasi-co-located (QCLed) when the first and second candidate SSB occasions have a same index.

5. The UE of claim 1, wherein:
a first frequency location of the first SSB is same as a second frequency location of the second SSB,
a first transmission power of the first SSB is same as a second transmission power of the second SSB,
a first cell identity of the first SSB is same as a second cell identity of the second SSB, and
a first set of SSB indexes for the first SSB is same as a second set of SSB indexes for the second SSB.

6. The UE of claim 1, wherein:
the set of higher layer parameters further includes a bitmap indicating actually transmitted SSB indexes, and
bits in the bitmap not corresponding to the first set of candidate SSB occasions are set to 0.

7. The UE of claim 1, wherein the first SSB is a periodic SSB and the second SSB is an on-demand SSB.

8. A method of a user equipment (UE) in a wireless communication system, the method comprising:
receiving a set of higher layer parameters, the set of higher layer parameters including a time offset, a first configuration for a first synchronization signals block (SSB), and a second configuration for a second SSB;
determining, based on the first configuration, a first set of candidate SSB occasions in a half frame for the first SSB;
determining, based on the second configuration, a second set of candidate SSB occasions in the half frame for the second SSB, wherein the second set of candidate SSB occasions occurs after the first set of candidate SSB occasions with respect to the time offset; and
receiving a SSB based on the first and second sets of candidate SSB occasions.

9. The method of claim 8, wherein the time offset is larger than 0 and smaller than the half frame.

10. The method of claim 8, wherein the first set of candidate SSB occasions start from a beginning of the half frame.

11. The method of claim 8, wherein:
the first and second sets of candidate SSB occasions are indexed from 0 in a time domain, and
a first candidate SSB occasion from the first set of candidate SSB occasions and a second candidate SSB occasion from the second set of candidate SSB occasions are quasi-co-located (QCLed) when the first and second candidate SSB occasions have a same index.

12. The method of claim 8, wherein:
a first frequency location of the first SSB is same as a second frequency location of the second SSB,
a first transmission power of the first SSB is same as a second transmission power of the second SSB,
a first cell identity of the first SSB is same as a second cell identity of the second SSB, and
a first set of SSB indexes for the first SSB is same as a second set of SSB indexes for the second SSB.

13. The method of claim 8, wherein:
the set of higher layer parameters further includes a bitmap indicating actually transmitted SSB indexes, and
bits in the bitmap not corresponding to the first set of candidate SSB occasions are set to 0.

14. The method of claim 8, wherein the first SSB is a periodic SSB and the second SSB is an on-demand SSB.

15. A base station (BS) in a wireless communication system, the BS comprising:
a transceiver configured to transmit a set of higher layer parameters, the set of higher layer parameters including a time offset, a first configuration for a first synchronization signals block (SSB), and a second configuration for a second SSB; and
a processor operably coupled to the transceiver, the processor configured to:
determine, based on the first configuration, a first set of candidate SSB occasions in a half frame for the first SSB; and
determine, based on the second configuration, a second set of candidate SSB occasions in the half frame for the second SSB,
wherein the second set of candidate SSB occasions occurs after the first set of candidate SSB occasions with respect to the time offset, and
wherein the transceiver is further configured to transmit a SSB based on the first and second sets of candidate SSB occasions.

16. The BS of claim 15, wherein the time offset is larger than 0 and smaller than the half frame, and the first set of candidate SSB occasions start from a beginning of the half frame.

17. The BS of claim 15, wherein:
the first and second sets of candidate SSB occasions are indexed from 0 in a time domain, and
a first candidate SSB occasion from the first set of candidate SSB occasions and a second candidate SSB occasion from the second set of candidate SSB occasions are quasi-co-located (QCLed) when the first and second candidate SSB occasions have a same index.

18. The BS of claim 15, wherein:
a first frequency location of the first SSB is same as a second frequency location of the second SSB,
a first transmission power of the first SSB is same as a second transmission power of the second SSB,
a first cell identity of the first SSB is same as a second cell identity of the second SSB, and
a first set of SSB indexes for the first SSB is same as a second set of SSB indexes for the second SSB.

19. The BS of claim 15, wherein:
the set of higher layer parameters further includes a bitmap indicating actually transmitted SSB indexes, and
bits in the bitmap not corresponding to the first set of candidate SSB occasions are set to 0.

20. The BS of claim 15, wherein the first SSB is a periodic SSB and the second SSB is an on-demand SSB.
